(19) United States
(12) Patent Application Publication
(10) Pub. No.: US 2005/0027558 A1
(43) Pub. Date: Feb. 3, 2005

(54) System, method and program for certificate issuance

(75) Inventor: Hidehiko Yamamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/920,378

(22) Filed: Aug. 18, 2004

Related U.S. Application Data
(63) Continuation of application No. PCT/JP02/03081, filed on Mar. 28, 2002.

(51) Int. Cl. G06F 17/60

(52) U.S. Cl. 705/1; 705/7

(57) ABSTRACT

At an acceptance terminal 10, a desired self-governing community and standard input items 80 necessary for certificate issuance application are entered by using a touch panel display 11 or by inserting a resident registration card into a card read section 12. The entered information is transmitted from the acceptance terminal 10 to a terminal operations center 40. An acceptance terminal operations server 41 of the terminal operations center 40 acquires format information concerning an application form for certificate issuance used in the self-governing community entered as stated above from a format management database 42 on the basis of the entered information, and prepares an application form for certificate issuance used in the above-described self-governing community by using the standard input items 80 on the basis of the acquired format information.

### TECHNICAL FIELD

The present invention relates to a certificate issuance application system, a certificate issuance application method, a certificate issuance application program, a certificate issuing system, a certificate issuing method, and a certificate issuing program that are capable of automatically executing issuance application processing or issuing processing with regard to various certificates, e.g. a certificate of residence, and a document certifying that one's seal is registered, which are issued by local governments, in response to a user entering necessary items.

### BACKGROUND ART

Conventionally, services for issuing various certificates e.g. a certificate of residence, and a document certifying that one's seal is registered, which are provided by local governments, e.g. municipal offices, are available at the municipal offices only on weekdays. At present, however, there is an increasing number of local governments that provide services for issuing certificates at places besides municipal offices and even on Saturdays and Sundays in compliance with the demand from residents. More specifically, terminal machines known as “certificate issuing machines” are installed at suitable places in the downtown area other than municipal offices to issue certificates even on Saturdays and Sundays.

FIG. 13 is an external view of a conventional certificate issuing machine. FIG. 14 is a diagram showing the basic arrangement of a certificate issuing system using the conventional certificate issuing machine. A description of the internal arrangement of the certificate issuing machine is omitted. As shown in FIG. 13, the conventional certificate issuing machine 300 comprises the following sections. A display/input section 301 displays instructions concerning certificate issuance application processing or allows the user to enter necessary information. A card read section 302 reads a resident registration card or the like. A coin slot 303 and a bill inlet 304 constitute a section through which the user pays a fee. A coin outlet 305 dispenses change. A receipt output section 306 prints out and outputs a receipt or the like. A certificate issuing section 307 issues a certificate.

Further, as shown in FIG. 14, the conventional certificate issuing machine 300 is connected via a network 400 to a certificate issuing host system 500 of a local government that stores and manages resident registration data, etc. The certificate issuing host system 500 comprises an operations server 501 that manages and operates the conventional certificate issuing machine 300. The certificate issuing host system 500 further comprises a management database 502 containing resident registration data, etc., and a host computer 503 that controls and manages the whole certificate issuing host system 500.

In this system, first, the user inserts his or her resident registration card into the card read section 302 of the conventional certificate issuing machine 300 to perform authentication. Then, the user enters information indicating what type of document he or she needs from the display/input section 301. Next, the user pays an issuance fee from the coin slot 303 or the bill inlet 304. At this time, change is delivered from the coin outlet 305 as occasion demands. At the step where the fee has been paid, the certificate issuance application is completed. Then, the conventional certificate issuing machine 300 establishes a communication connection with the host system 500. The host computer 503 refers to the management database 502 according to the application contents received, and prepares a certificate. The prepared certificate is transmitted from the operations server 501 to the conventional certificate issuing machine 300. The user can receive the transmitted certificate from the certificate issuing section 307 of the conventional certificate issuing machine 300.

The above-described system (conventional certificate issuing machine 300) is installed solely in a municipal office, a public hall, etc. in many cases.

Actually, however, citizens do not always lead lives within self-governing communities where their residence is registered. For example, one's place of residence may be Kanagawa prefecture in Japan, but his or her place of employment may be Tokyo. Therefore, it is naturally desirable that a terminal capable of issuing certificates should be installed in an area where a citizen actually leads an everyday life even if it is not where his or her residence is registered.

In the conventional system, however, one certificate issuing machine is associated with one self-governing community. Therefore, it is necessary in order to adapt the system for a plurality of self-governing communities to provide a plurality of certificate issuing machines that are associated with the self-governing communities, respectively. Consequently, a great deal of installation cost and a wider installation space would be required. Accordingly, it is difficult to provide such equipment at a plurality of suitable places in each self-governing community. In addition, the number of installation places is limited. Hence, it cannot be expected that there will be a great improvement in resident's convenience.

The present invention was made to solve the above-described problems. It is an object of the present invention to provide a certificate issuance application system, a certificate issuance application method, a certificate issuance application program, a certificate issuing system, a certificate issuing method, and a certificate issuing program that allow one terminal to be shared by a plurality of self-governing communities so that a plurality of self-governing communities can be accessed by using a single terminal, thereby enabling certificate issuance application to be made easily.

### DISCLOSURE OF THE INVENTION

The present invention provides a certificate issuance application system including the following sections: a first input section through which an applicant selects and enters a desired self-governing community; a second input section through which the applicant enters predetermined information necessary for certificate issuance application; a format acquiring section that acquires from a predetermined storage section format information concerning an application form for certificate issuance that is used in the self-governing community selected and entered through the first input section; and an application form preparing section that prepares an application form for certificate issuance that is used in the self-governing community selected and entered through the first input section by using the predetermined information entered through the second input section on the basis of the format information acquired by the format acquiring section.

With the above-described arrangement, the certificate issuance application system can be shared by a plurality of self-governing communities. For example, it is possible to access a plurality of self-governing communities by using only one terminal. Accordingly, it becomes unnecessary to install a plurality of terminals for application associated with a plurality of self-governing communities, respectively. Further, when an application form is to be prepared, format information specific to each self-governing community can be acquired easily. Therefore, even if the formats of various application forms differ for each self-governing community, a desired application form can be prepared easily. Further, because an application form is automatically prepared once necessary items are entered, the manner of handling at the time of data entry can be made common to self-governing communities. Accordingly, the terminal operating method will not become complicated. Thus, it is possible to provide a system that is easy for users to use.

It should be noted that in an embodiment of the present invention the first input section comprises a card read section and a main control section of an acceptance terminal. The second input section comprises a touch panel display of the acceptance terminal, together with the card read section and the main control section. The format acquiring section and the application form preparing section comprise an application form preparing section of an acceptance terminal operations server. The predetermined storage section comprises a format management database.

The certificate issuance application system according to the present invention further includes a third input section through which the applicant enters the type of certificate desired to be issued. The format acquiring section acquires from the predetermined storage section format information concerning the issuance application form used in the self-governing community selected and entered through the first input section on the basis of the type of certificate entered through the third input section.

With the above-described arrangement, it is possible to execute processing in conformity to various application forms handled in self-governing communities, e.g. an application form for the issuance of a residence certificate, an application form for the issuance of a document certifying that one's name seal is registered, and an application form for the issuance of a tax payment certificate. Thus, it becomes possible to provide highly convenient services for users.

It should be noted that in the embodiment of the present invention the third input section comprises the touch panel display and the main control section of the acceptance terminal.

Further, in the certificate issuance application system according to the present invention, the selective entry processing performed through the first input section is carried out by using a predetermined storage medium storing at least information for identifying a self-governing community to which the applicant belongs.

With the above-described arrangement, it is possible to save the time and labor needed for the user to enter information and also possible to prevent a data entry mistake. Accordingly, it becomes possible to perform application processing with high reliability.

It should be noted that in the embodiment of the present invention the predetermined storage medium corresponds to a resident registration card.

Further, in the certificate issuance application system according to the present invention, the first input section has a read unit that reads information stored in the predetermined storage medium.

With the above-described arrangement, if the predetermined storage medium is a resident registration card, for example, the entry of a self-governing community is completed simply by the user inserting the resident registration card into a resident registration card reader (read unit). Accordingly, the entry processing speeds up. In addition, because the entry of information is completed by a simple operation, it is possible to provide a system that is easy for users to use.

It should be noted that in the embodiment of the present invention, the read unit comprises the card read section of the acceptance terminal.

Further, in the certificate issuance application system according to the present invention, the predetermined storage medium is at least either a magnetic card or an IC card.

With the above-described arrangement, information concerning a self-governing community can be stored in a lightweight card, i.e. a magnetic card or an IC card. Accordingly, it is easy for the user to carry the storage medium with him or her. The operation for entering information is also facilitated.

The certificate issuance application system according to the present invention further includes a judging section that judges whether or not predetermined information to be entered through the second input section has been stored in the predetermined storage medium used in the first input section. Further, the certificate issuance application system includes a storing section that stores in the predetermined storage medium predetermined information entered by the applicant during the entry processing performed through the second input section when the judging section judges that the predetermined information has not been stored. When the judging section judges that the predetermined information has been stored, the entry processing performed through the second input section is carried out by using the predetermined storage medium.

With the above-described arrangement, various information necessary for certificate issuance application is automatically stored in the predetermined storage medium in addition to the information concerning the self-governing community. Therefore, when the user makes the same application as the previous one, or when information to be entered is the same as the previous one, it is unnecessary to enter the same information again. Accordingly, it becomes possible to simplify the application processing.

It should be noted that in the embodiment of the present invention the judging section comprises the main control section of the acceptance terminal, and the storing section comprises the main control section and the card read section of the acceptance terminal.

Further, in the certificate issuance application system according to the present invention, the format information acquired by the format acquiring section includes at least one of information concerning items written on an application form, the number of digits of each item, and the position of each item on an application form sheet.

With the above-described arrangement, an application form can be prepared easily in conformity to the format of an application form specific to each self-governing community.

Further, in the certificate issuance application system according to the present invention, the predetermined information entered through the second input section is the contents of each item to be written on the application form. The application form preparing section arranges the contents of each item entered through the second input section according to the format information acquired by the format acquiring section to prepare an issuance application form.

With the above-described arrangement, it is possible to prepare flexibly an application form conformable to the application form format specific to each self-governing community.

The certificate issuance application system according to the present invention further includes a fourth input section through which the applicant enters information concerning his or her account at a financial institution, and a connecting section that is capable of connecting to a deposit management system of the financial institution. Further, the certificate issuance application system includes a fee transfer section that transfers through the connecting section a certificate issuance fee from the user's account at the financial institution into an account of the self-governing community entered through the first input section on the basis of the information entered through the fourth input section.

With the above-described arrangement, the certificate issuance fee, which has heretofore been collected in cash, can be paid directly from the user's bank account. Accordingly, convenience improves. In addition, it becomes unnecessary to carry out security management that would otherwise be required in connection with cash collection and cash storage. Hence, it becomes possible to reduce the system running costs.

It should be noted that in the embodiment of the present invention the fourth input section comprises the card read section and the main control section of the acceptance terminal. The connecting section comprises a communication control section and the main control section of the acceptance terminal, and a communication controller of a terminal operations center, together with a communication interface of the acceptance terminal operations server. Further, the fee transfer section comprises a financial institution server and an account management database of a financial institution host system.

Further, in the certificate issuance application system according to the present invention, the fourth input section has a card reader that reads the contents of a cash card or a credit card of the financial institution. Entry processing performed through the fourth input section is carried out by reading the contents of a cash card or a credit card of the financial institution with the card reader.

With the above-described arrangement, the certificate issuance fee can be paid easily by using a cash card or a credit card. Therefore, the user's application processing is simplified. In addition, it becomes possible for the self-governing community to collect the fee easily.

It should be noted that in the embodiment of the present invention the card reader comprises the card read section and the main control section of the acceptance terminal.

The certificate issuance application system according to the present invention further includes an application form transmitting section that transmits the application form prepared by the application form preparing section to the self-governing community entered through the first input section.

With the above-described arrangement, the prepared application form is rapidly transmitted to the self-governing community. Therefore, the certificate issuance application processing speeds up. Hence, it becomes possible to shorten the time required for the certificate issuance.

It should be noted that in the embodiment of the present invention the application form transmitting section comprises the communication controller of the terminal operations center and an application form transmitting section and the communication interface of the acceptance terminal operations server.

Further, in the certificate issuance application system according to the present invention, the first input section and the second input section are installed at a plurality of places as application acceptance terminal apparatus. Each application acceptance terminal apparatus is connected to a host computer having the format acquiring section and the application form preparing section through a telecommunication circuit.

With the above-described arrangement, if the application acceptance terminal apparatus is installed at various places, users can perform certificate issuance application processing from various places. Accordingly, convenience in making an application improves. In addition, because the function of the application acceptance terminal apparatus is limited to the input function, application acceptance can be executed with a minimal hardware configuration. Consequently, the application acceptance terminal apparatus can be reduced in size, and hence the installation space can be minimized. Therefore, restrictions on the installation place reduce remarkably.

It should be noted that in the embodiment of the present invention, the application acceptance terminal apparatus corresponds to the acceptance terminal. The host computer corresponds to the acceptance terminal operations server of the terminal operations center.

In addition, the present invention provides an application acceptance terminal apparatus including the following sections: a first input section through which an applicant selects and enters a desired self-governing community; a second input section through which the applicant enters predetermined information necessary for certificate issuance application; and a communication section that connects through a telecommunication circuit to a host computer having a format acquiring section that acquires from a predetermined storage section format information concerning an application form for certificate issuance that is used in the self-governing community selected and entered through the first input section, and an application form preparing section that prepares an application form for certificate issuance that is used in the self-governing community selected and entered through the first input section by using the predetermined information entered through the second input section on the basis of the format information acquired by the format acquiring section.

In addition, the present invention provides a host computer including a communication section that connects through a telecommunication circuit to an application acceptance terminal apparatus having a first input section through which an applicant selects and enters a desired self-governing community. The application acceptance terminal apparatus further has a second input section through which the applicant enters predetermined information necessary for certificate issuance application. The communication section is capable of receiving data entered at the application acceptance terminal apparatus. The host computer further includes a format acquiring section that acquires from a predetermined storage section format information concerning an application form for certificate issuance that is used in the self-governing community selected and entered through the first input section, and an application form preparing section that prepares an application form for certificate issuance that is used in the self-governing community selected and entered through the first input section by using the predetermined information entered through the second input section on the basis of the format information acquired by the format acquiring section.

In addition, the present invention provides a certificate issuance application method including the following steps: a first input step at which an applicant selects and enters a desired self-governing community; a second input step at which the applicant enters predetermined information necessary for certificate issuance application; a format acquiring step at which format information concerning an application form for certificate issuance that is used in the self-governing community selected and entered at the first input step is acquired from a predetermined storage section; and an application form preparing step at which an application form for certificate issuance that is used in the self-governing community selected and entered at the first input step is prepared by using the predetermined information entered at the second input step on the basis of the format information acquired at the format acquiring step.

Further, the certificate issuance application method according to the present invention includes an application form transmitting step at which the application form prepared at the application form preparing step is transmitted to the self-governing community entered at the first input step.

In addition, the present invention provides a certificate issuance application program stored in a computer-readable storage medium to instruct a computer to execute certificate issuance application processing. The program instructs the computer to execute the following steps: a first input step at which an applicant selects and enters a desired self-governing community; a second input step at which the applicant enters predetermined information necessary for certificate issuance application; a format acquiring step at which format information concerning an application form for certificate issuance that is used in the self-governing community selected and entered at the first input step is acquired from a predetermined storage section; and an application form preparing step at which an application form for certificate issuance that is used in the self-governing community selected and entered at the first input step is prepared by using the predetermined information entered at the second input step on the basis of the format information acquired at the format acquiring step.

Further, the certificate issuance application program according to the present invention instructs the computer to execute an application form transmitting step at which the application form prepared at the application form preparing step is transmitted to the self-governing community entered at the first input step.

It should be noted that in the present invention examples of the computer-readable storage medium include portable storage mediums, e.g. CD-ROMs, flexible disks, DVD disks, optical magnetic disks, and IC cards, databases retaining computer programs, other computers, databases thereof, and transmission mediums on communication lines.

In addition, the present invention provides a certificate issuing system including the following sections: a first input section through which an applicant selects and enters a desired self-governing community; a second input section through which the applicant enters predetermined information necessary for certificate issuance application; a format acquiring section that acquires from a predetermined storage section format information concerning an application form for certificate issuance that is used in the self-governing community selected and entered through the first input section; an application form preparing section that prepares an application form for certificate issuance that is used in the self-governing community selected and entered through the first input section by using the predetermined information entered through the second input section on the basis of the format information acquired by the format acquiring section; an application form transmitting section that transmits the application form prepared by the application form preparing section to the self-governing community entered through the first input section; a certificate preparing section that prepares a certificate based on the application form transmitted by the application form transmitting section; and a certificate issuing section that issues the certificate prepared by the certificate preparing section.

With the above-described arrangement, when an application form is to be prepared, format information specific to each self-governing community can be acquired easily. Therefore, even if the formats of various application forms differ for each self-governing community, a desired application form can be prepared easily. Further, a certificate is automatically prepared according to the contents of the application form. Therefore, the certificate preparation speeds up, and the time required until the desired certificate is issued is reduced to a considerable extent. Further, the manner of handling at the time of entry of data for application can be made common to self-governing communities. Accordingly, the terminal operating method will not become complicated. Thus, it is possible to provide a system that is easy for users to use.

In addition, the present invention provides a certificate issuing method including the following steps: a first input step at which an applicant selects and enters a desired self-governing community; a second input step at which the applicant enters predetermined information necessary for certificate issuance application; a format acquiring step at which format information concerning an application form for certificate issuance that is used in the self-governing community selected and entered at the first input step is acquired from a predetermined storage section; an application form preparing step at which an application form for certificate issuance that is used in the self-governing community selected and entered at the first input step is prepared by using the predetermined information entered at the second input step on the basis of the format information acquired at the format acquiring step; an application form transmitting step at which the application form prepared at the application form preparing step is transmitted to the self-governing community entered at the first input step; a certificate preparing step at which a certificate is prepared based on the application form transmitted at the application form transmitting step; and a certificate issuing step at which the certificate prepared at the certificate preparing step is issued.

In addition, the present invention provides a certificate issuing program stored in a computer-readable storage medium to instruct a computer to execute certificate issuing processing. The program instructs the computer to execute the following steps: a first input step at which an applicant selects and enters a desired self-governing community; a second input step at which the applicant enters predetermined information necessary for certificate issuance application; a format acquiring step at which format information concerning an application form for certificate issuance that is used in the self-governing community selected and entered at the first input step is acquired from a predetermined storage section; an application form preparing step at which an application form for certificate issuance that is used in the self-governing community selected and entered at the first input step is prepared by using the predetermined information entered at the second input step on the basis of the format information acquired at the format acquiring step; an application form transmitting step at which the application form prepared at the application form preparing step is transmitted to the self-governing community entered at the first input step; a certificate preparing step at which a certificate is prepared based on the application form transmitted at the application form transmitting step; and a certificate issuing step at which the certificate prepared at the certificate preparing step is issued.

It should be noted that in the present invention examples of the computer-readable storage medium include portable storage mediums, e.g. CD-ROMs, flexible disks, DVD disks, optical magnetic disks, and IC cards, databases retaining computer programs, other computers, databases thereof, and transmission mediums on communication lines.

### BRIEF DESCRIPTION OF THE DRAWINGS

FIG. 1 is a diagram showing the basic arrangement of a certificate issuing system according to an embodiment of the present invention.

FIG. 2 is an external view of an acceptance terminal.

FIG. 3 is a block diagram showing the functional arrangement of the acceptance terminal.

FIG. 4 is an external view of a certificate issuing machine.

FIG. 5 is a block diagram showing the functional arrangement of the certificate issuing machine.

FIG. 6 is a block diagram showing the functional arrangement of an acceptance terminal operations server of a terminal operations center.

FIG. 7 is a flowchart showing certificate issuance application processing at the acceptance terminal.

FIG. 8 is a diagram specifically showing the outline of application form preparing processing.

FIG. 9 is a diagram specifically showing a format adjusting method carried out by the acceptance terminal operations server.

FIG. 10 illustrates an application form prepared on the basis of format data used in City A.

FIG. 11 illustrates an application form prepared on the basis of format data used in City B.

FIG. 12 is a flowchart showing certificate issuing processing carried out by the certificate issuing machine.

FIG. 13 is an external view of a conventional certificate issuing machine.

FIG. 14 is a diagram showing the basic arrangement of a certificate issuing system using the conventional certificate issuing machine.

### BEST MODE FOR CARRYING OUT THE INVENTION

An embodiment of the present invention will be described below in detail with reference to the accompanying drawings.

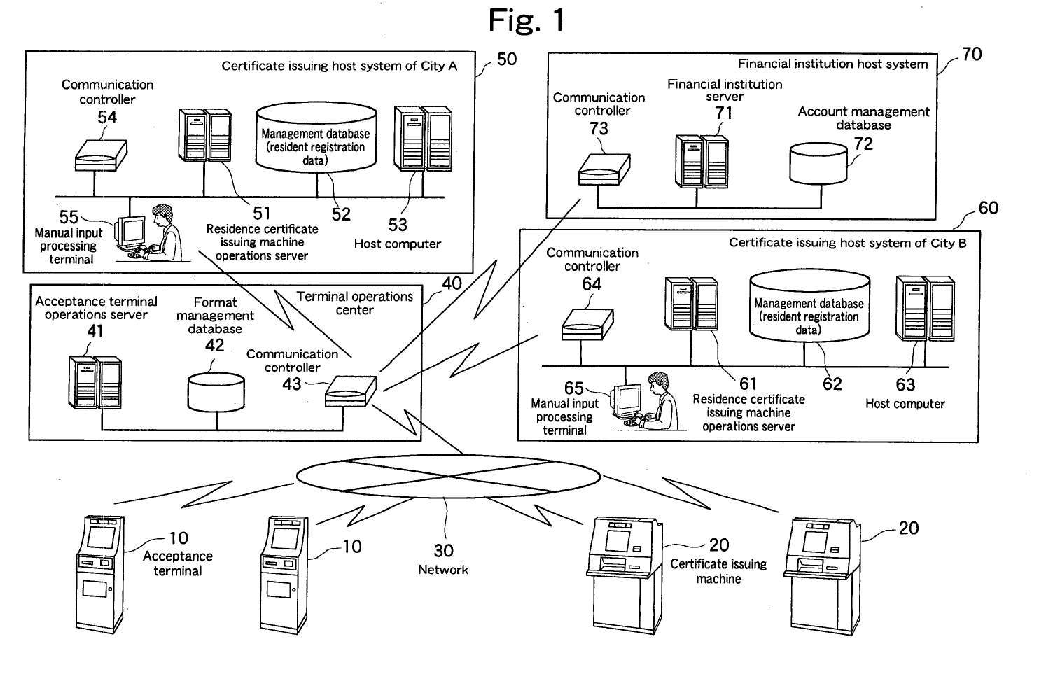

FIG. 1 is a diagram showing the basic arrangement of a certificate issuing system in an embodiment of the present invention. As shown in the figure, the certificate issuing system comprises acceptance terminals 10, certificate issuing machines 20, a terminal operations center 40, and a financial institution host system 70. The terminal operations center 40 is connected with a certificate issuing host system of each self-governing community (in the figure, the terminal operations center 40 is connected with a certificate issuing host system 50 of a self-governing community A and a certificate issuing host system 60 of a self-governing community B).

The acceptance terminals 10 accept application for the issuance of certificate documents. The acceptance terminals 10 are capable of accepting application for the issuance of certificates from various self-governing communities. Therefore, the acceptance terminals 10 are installed at various places where applicants can use them easily.

The certificate issuing machines 20 issue certificate.

The terminal operations center 40 is connected to the acceptance terminals 10, the certificate issuing machines 20, the financial institution host system 70, and the certificate issuing host system of each self-governing community to manage certificate issuance application processing, issuance fee transfer processing and certificate issuing processing.

The financial institution host system 70 transfers an issuance fee from an applicant's account into an account of the relevant self-governing community on the basis of a terminal operation performed at an acceptance terminal 10.

Each of the constituent elements will be described below in detail.

The terminal operations center 40 has an acceptance terminal operations server 41, a format management database 42, and a communication controller 43. The communication controller 43 controls communications with external systems, i.e. the acceptance terminals 10, the certificate issuing machines 20, certificate issuing host systems (50 and 60) of self-governing communities, and the financial institution host system 70. The format management database 42 is a database storing format information necessary for application form preparation. The acceptance terminal operations server 41 receives data necessary for application form preparation from an acceptance terminal 10 through the communication controller 43 and prepares an application form by referencing the format management database 42. Further, the acceptance terminal operations server 41 transmits the prepared application form to the relevant self-governing community. Alternatively, the acceptance terminal operations server 41 receives certificate data from the self-governing community and transmits it to a certificate issuing machine 20.

The certificate issuing host system 50 of City A has a residence certificate issuing machine operations server 51, a management database 52, a host computer 53, a communication controller 54, and a manual input processing terminal 55. The communication controller 54 controls communications with the terminal operations center 40. The management database 52 is a database storing resident registration data, etc. The residence certificate issuing machine operations server 51 carries out the preparation of certificates, e.g. residence certificates, and transmits certificate data to a certificate issuing machine 20 via the terminal operations center 40. The host computer 53 receives a certificate issuance application form from the terminal operations center 40, and controls the residence certificate issuing machine operations server 51, the management database 52, the communication controller 54, and the manual input processing terminal 55. It should be noted that the manual input processing terminal 55 is a terminal that is used by a staff member at the self-governing community office to refer to data managed by the host computer 53 and to perform entry and confirmation of data concerning certificate issuance, e.g. confirmation of the received application form, and provision of certificate issuing instructions.

The arrangement of the certificate issuing host system 60 of City B is the same as that of the system of City A.

The financial institution host system 70 has a financial institution server 71, an account management database 72, and a communication controller 73. The communication controller 73 controls communications with the terminal operations center 40. The account management database 72 is a database storing information concerning clients' accounts. The financial institution server 71 manages clients' accounts.

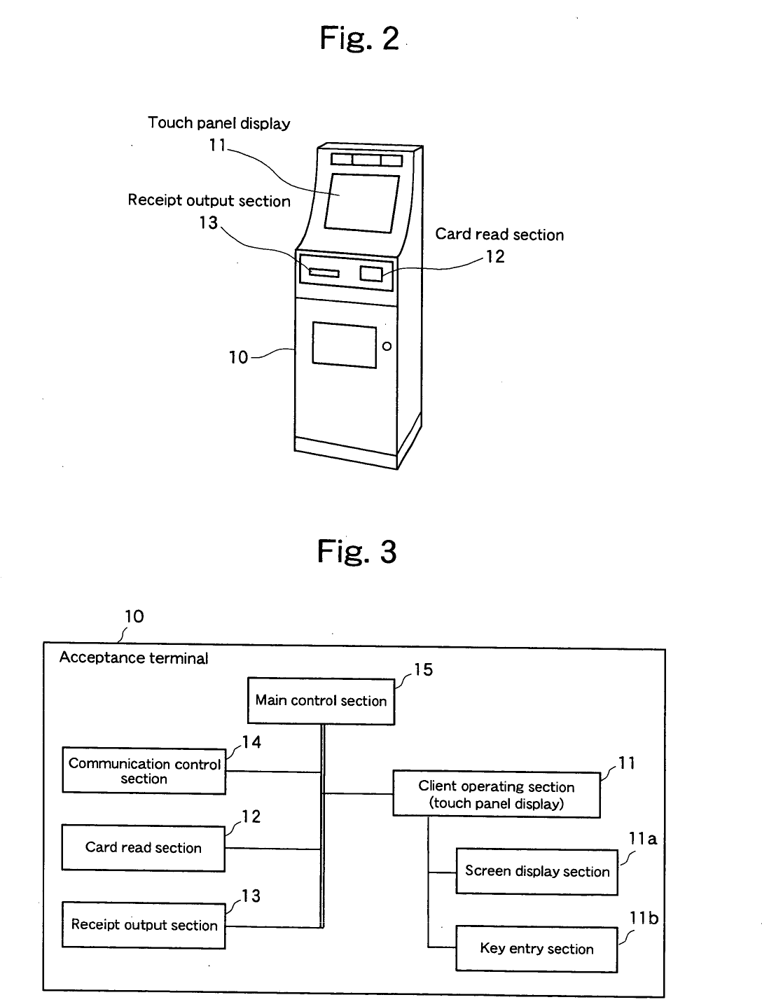

FIG. 2 is an external view of an acceptance terminal 10. The acceptance terminal 10 has a touch panel display 11, a card read section 12, and a receipt output section 13.

FIG. 3 is a block diagram showing the functional arrangement of the acceptance terminal 10. As shown in the figure, the acceptance terminal 10 comprises a client operating section (touch panel display) 11, a card read section 12, a receipt output section 13, a communication control section 14, and a main control section 15. The client operating section 11 has a screen display section 11a and a key entry section 11b. The screen display section 11a displays guidance for the user. The key entry section 11b accepts entry of data from the user. The card read section 12 reads information recorded on a resident registration card and a cash card. In this embodiment, the card read section 12 has the function of writing data onto a resident registration card in addition to the read function. The receipt output section 13 issues a receipt at the time of acceptance. The communication control section 14 performs communications with the acceptance terminal operations server 41 of the terminal operations center 40. The main control section 15 controls each of the above-described constituent elements. It should be noted that the acceptance terminal 10 has a storage medium (not shown) containing a program group needed for the acceptance terminal 10 to operate. The program group is loaded into a memory provided in the acceptance terminal 10, whereby the above-described functions are executed.

It should be noted that in this embodiment an IC card is used as a resident registration card, which is issued on a community-by-community basis. Each resident registration card contains information indicating a self-governing community and an individual ID that identifies a resident for each self-governing community. When a certificate is to be issued, the residence certificate issuing machine operations server of the relevant self-governing community references the management database of the self-governing community by using the ID. In addition, the acceptance terminal 10 can record information necessary for certificate issuance application onto the resident registration card. The recorded information will be used next time the user makes an application. Thus, it is possible to eliminate the time and labor that would otherwise be required to enter the necessary information.

Further, the card read section 12 is arranged to be capable of reading cash cards of financial institutions in addition to resident registration cards. Thus, the card read section 12 can identify each card inserted to perform processing appropriately.

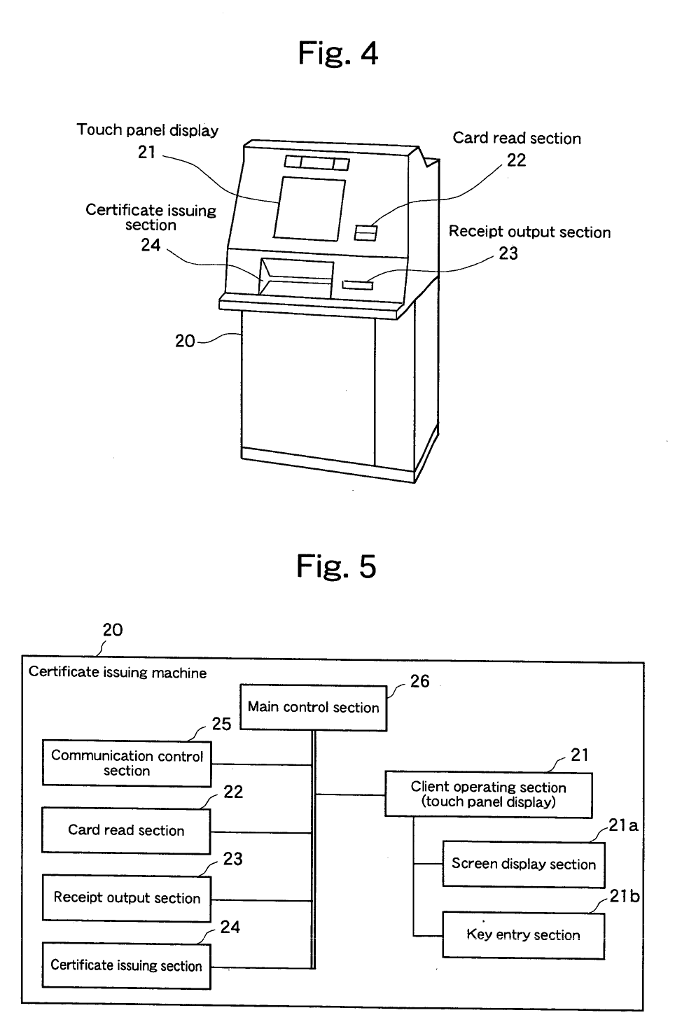

FIG. 4 is an external view of a certificate issuing machine 20. The certificate issuing machine 20 has a touch panel display 21, a card read section 22, a receipt output section 23, and a certificate issuing section 24.

FIG. 5 is a block diagram showing the functional arrangement of the certificate issuing machine 20. As shown in the figure, the certificate issuing machine 20 comprises a client operating section (touch panel display) 21, a card read section 22, a receipt output section 23, a certificate issuing section 24, a communication control section 25, and a main control section 26. The client operating section 21 has a screen display section 21a and a key entry section 21b. The screen display section 21a displays guidance for the user. The key entry section 21b accepts entry of data from the user. The card read section 22 reads information recorded on a resident registration card and a cash card. The receipt output section 23 issues a receipt at the time of transaction. The certificate issuing section 24 issues a certificate. The communication control section 25 performs communications with the acceptance terminal operations server 41 of the terminal operations center 40. The main control section 26 controls each of the above-described constituent elements.

It should be noted that the card read section 22 has functions similar to those of the card read section 12 of the acceptance terminal 10.

The acceptance terminal 10 and the certificate issuing machine 20 are not provided with a cash slot, etc. because the payment of a certificate issuance fee is settled with a cash card of a financial institution.

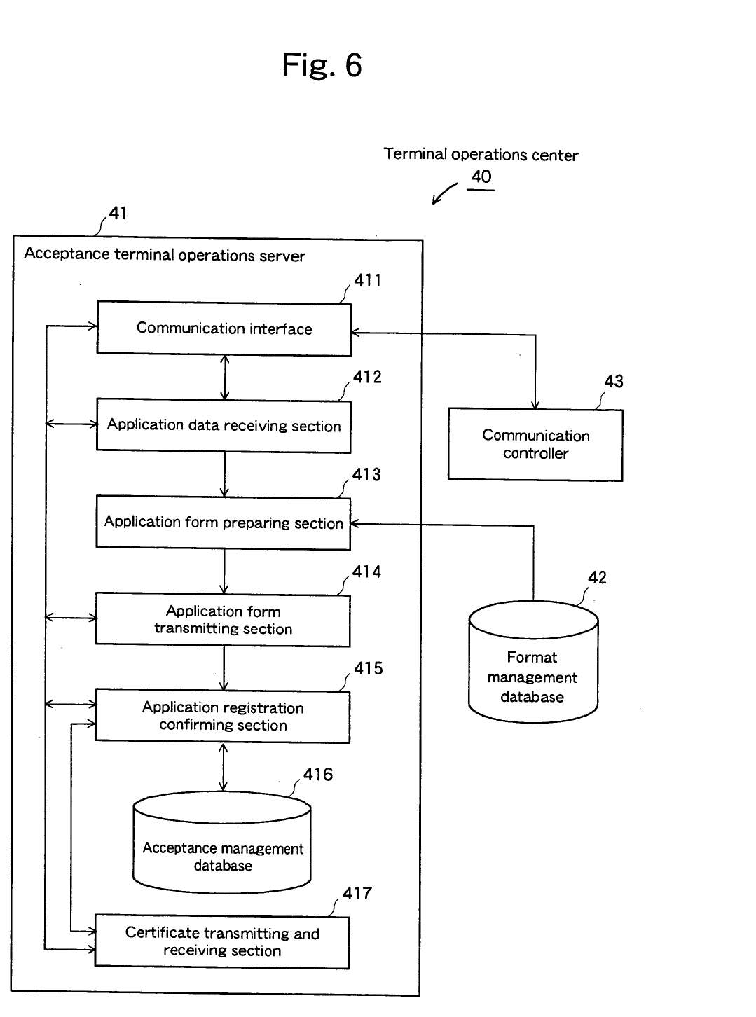

FIG. 6 is a block diagram showing in detail the functional arrangement of the acceptance terminal operations server 41 of the terminal operations center 40. As shown in the figure, the acceptance terminal operations server 41 has a communication interface 411 connected to the communication controller 43, an application data receiving section 412 that receives and processes application data transmitted from the acceptance terminal 10, an application form preparing section 413 that prepares an application form based on the received application data, an application form transmitting section 414 that transmits the prepared application form to the certificate issuing host system of the relevant self-governing community, an application registration confirming section 415 that registers the accepted application in an acceptance management database 416, and a certificate transmitting and receiving section 417 that receives a certificate issuing instruction from the certificate issuing machine 20 and further receives certificate data from the certificate issuing host system of the self-governing community and transmits the certificate data to the certificate issuing machine 20.

It should be noted that the above-described functions are executed by a program group loaded into a memory (not shown) from a storage medium (not shown), e.g. a hard disk, provided in the acceptance terminal operations server 41. It should be noted that the program group may be stored in a portable storage medium, e.g. a CD-ROM, and installed in the acceptance terminal operations server 41. Alternatively, the program group may be installed by downloading it from another computer through a communication circuit. In other words, there is no restriction on the manner of installing the program group.

Based on the above-described arrangements, certificate issuance application processing and certificate issuing processing will be described below in detail by using flowcharts.

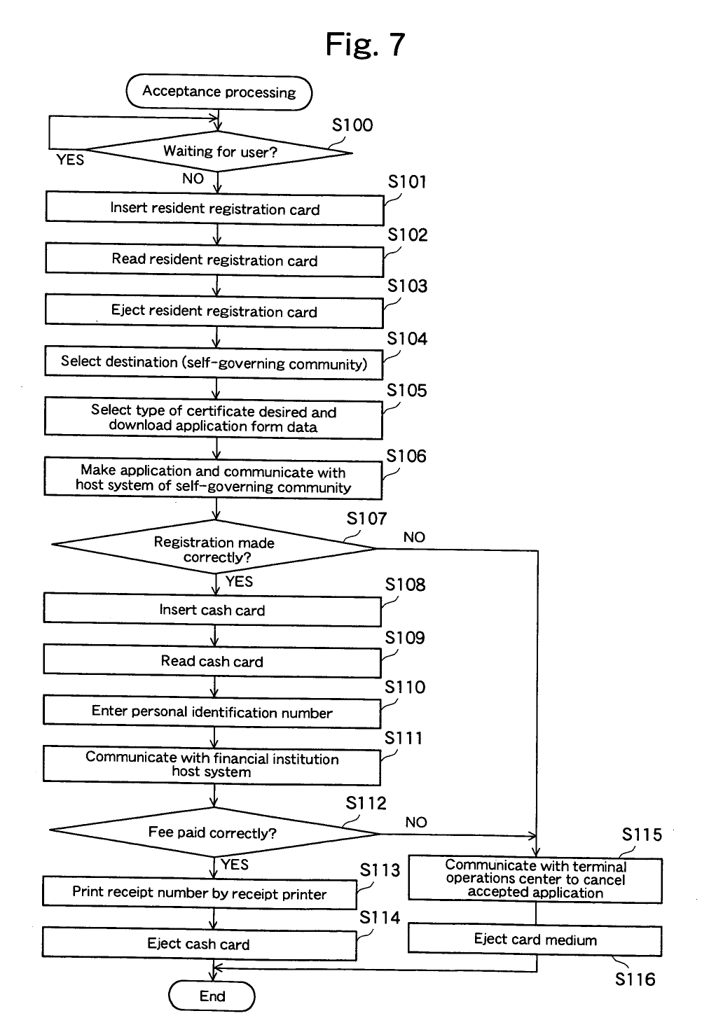

FIG. 7 is a flowchart showing certificate issuance application processing carried out at the acceptance terminal 10. When it is in a standby state, the acceptance terminal 10 continues to display input operation guidance (not shown) on the touch panel display 11 (S100).

Following the input operation guidance, the user inserts his or her resident registration card into the card read section 12 (S101). The card read section 12 reads information (ID) recorded on the resident registration card (S102). Further, the main control section 15 checks whether or not data necessary for certificate issuance application, i.e. the applicant's address, name, etc., has been recorded on the resident registration card. If the resident registration card has such data recorded thereon, application processing is carried out by using the information. If such data has not been recorded on the resident registration card, an instruction is displayed on the touch panel display 11 to prompt the user to enter necessary data. The user enters items, i.e. address, name, etc., according to the instruction. The entered data is recorded on the resident registration card by the card read section 12. It should be noted that data necessary for certificate issuance application is approximately the same irrespective of the type of certificate. Therefore, in this embodiment, standard input items have previously been set. At the time of making an application, the standard input items are entered by the applicant. The entered item information is recorded on the resident registration card and will be read out therefrom next time the user makes an application.

It should be noted that the data read out from the resident registration card at S102 is displayed on the touch panel display 11 so that the user can confirm it. If there is an error or change in the data, the user can correct the data by a manual input operation.

Upon completion of obtaining the necessary information, the resident registration card is ejected from the card read section 12 (S103). The main control section 15 identifies the relevant self-governing community on the basis of the obtained information and selects the self-governing community as a destination to which the acceptance terminal 10 is to be connected (S104).

Next, the user selects and enters the type of certificate desired to be issued on the touch panel display 11 (S105). In this embodiment, it is assumed that the user applies for issuance of a residence certificate.

All the data concerning application (application data) entered at the acceptance terminal 10 in this way is transmitted from the communication control section 14 to the terminal operations center 40. At the acceptance terminal operations server 41 of the terminal operations center 40, the application data receiving section 412 receives the application data through the communication interface 411. The application form preparing section 413 downloads format information necessary for application form preparation from the format management database 42 on the basis of the application data received by the application data receiving section 412 (S105).

It should be noted that the format management database 42 has format data stored therein for each type of certificate and for each self-governing community.

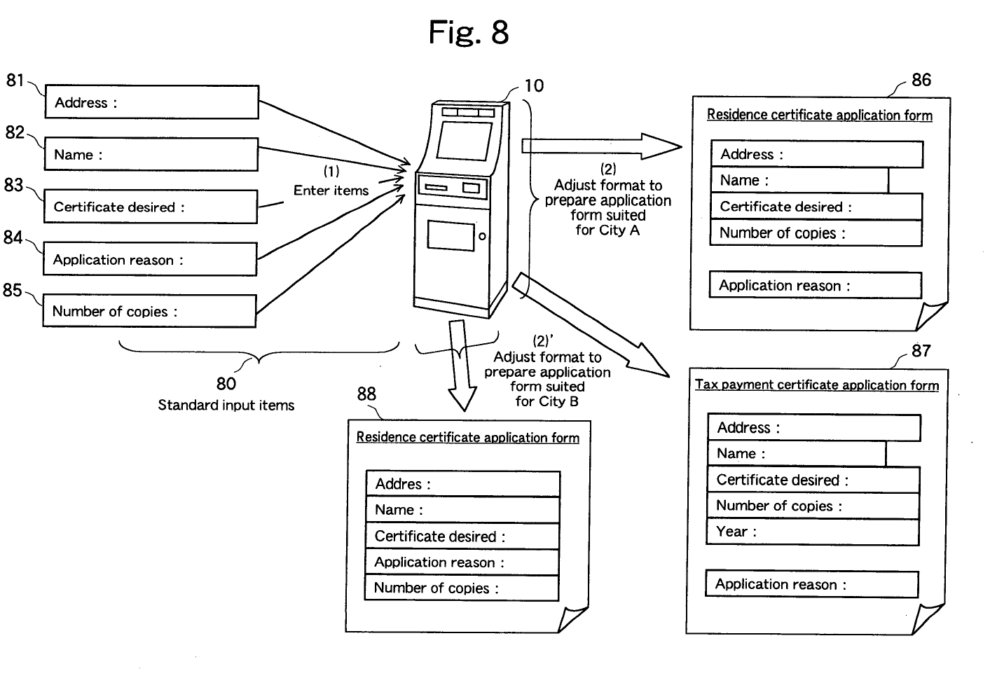

The application form preparing section 413 prepares an application form based on the downloaded format. FIG. 8 is a diagram specifically showing the outline of application form preparing processing carried out at S101 to S105. As shown in the figure, at the acceptance terminal 10, standard input items 80 are entered from the touch panel display 11 by the applicant or through the resident registration card (1). In this embodiment, Address 81, Name 82, Certificate desired 83, Application reason 84, and Number of copies 85 are standard input items 80. Data entered from the acceptance terminal 10 is output by the acceptance terminal operations server 41 in conformity to the format of application form used in each individual self-governing community. Thus, an application form is prepared. In the figure, by way of example, a residence certificate application form 86 and a tax payment certificate application form 87 are adjusted in format so as to be suited for City A (2), and a residence certificate application form 88 is adjusted in format so as to be suited for City B (2)′. Thus, even if the format of an application form differs for each self-governing community or the format of an application form differs according to the type of certificate to be issued, the acceptance terminal operations server 41 makes necessary adjustment of the format to prepare a proper application form.

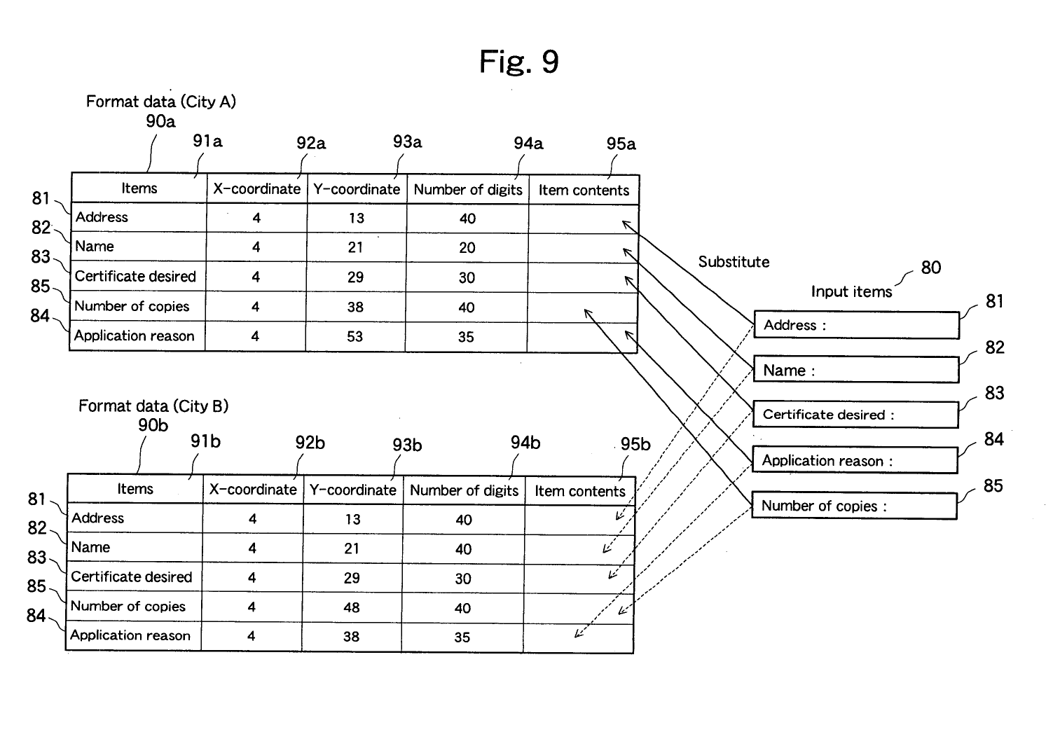

FIG. 9 is a diagram specifically showing the format adjusting method carried out by the acceptance terminal operations server 41. The figure shows format data 90a of City A and format data 90b of City B, which are downloaded from the format management database 42. As shown in the figure, the downloaded data is stored in a predetermined table and used for application form preparation. The format adjusting method will be described below with regard to the format data 90a of City A. The table stores X-coordinate 92a and Y-coordinate 93a of each item title 91a to be written on an application form, together with the number of digits 94a of each item as written. Further, the contents of the items 80 entered at the acceptance terminal 10 are stored in item contents 95a.

The application form preparing section 413 generates a document file newly as an application form and outputs the item contents 95a to the document file in conformity to the number of digits 94a specified by the format data 90a of City A at the coordinate position (92a, 93a) similarly specified.

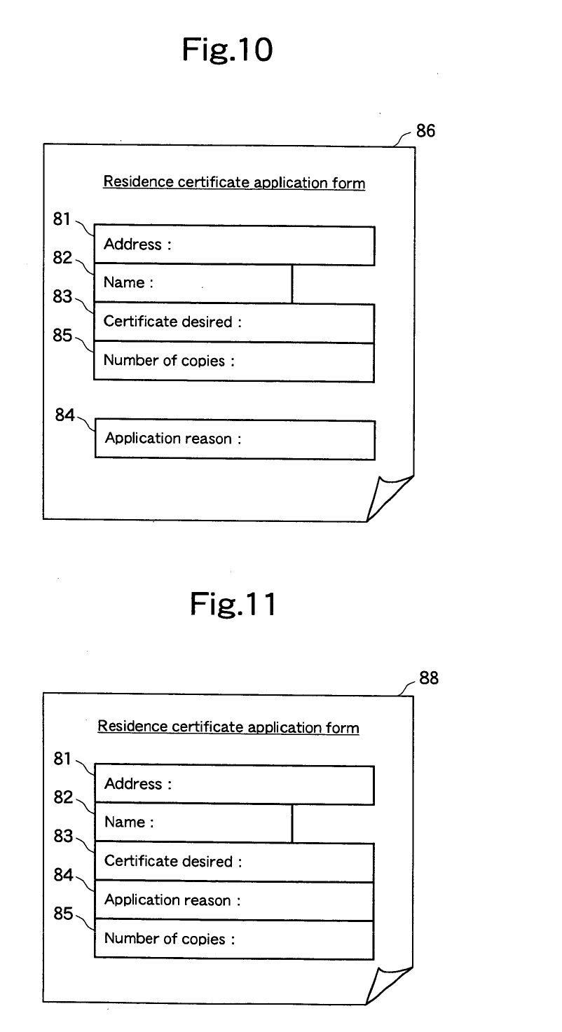

FIG. 10 shows a residence certificate application form 86 of City A prepared in this way. As shown in the figure, the number of digits of each item has been adjusted in conformity to the number of digits 94a, and the output position of each item has also been adjusted to a position defined by the X-coordinate 92a and the Y-coordinate 93a.

FIG. 11 shows a residence certificate application form 88 prepared on the basis of the format data 90b of City B. As will be clear from the figure, the lo format of the prepared application form is different from that of City A because the format data 90b of City B differs from the format data 90a of City A.

The application forms prepared in this way are transmitted to the certificate issuing host systems of the relevant self-governing communities from the application form transmitting section 414 (S106 in FIG. 7). Let us take the certificate issuing host system 50 of City A as an example. The application form received by the communication controller 54 is checked in terms of the format and the application items by the host computer 53. If the checked application form has no problem, it is registered formally as an application form in a predetermined storage section in the host computer 53.

Subsequently, a notice of registration is transmitted to the terminal operations center 40. Upon receiving the notice of registration, the application registration confirming section 415 of the acceptance terminal operations server 41 assigns a receipt number to the relevant application and stores a receipt record in the acceptance management database 416. Further, the application registration confirming section 415 transmits the notice of registration including the receipt number to the acceptance terminal 10. Thus, the acceptance terminal 10 can grasp whether or not registration has been made correctly. If registration has been made correctly (if YES at S107 in FIG. 7), the process proceeds to fee payment processing.

The user inserts his or her cash card of a financial institution into the card read section 12 (S108). The card read section 12 reads information recorded on the cash card (S109). Next, the main control section 15 instructs the user to enter his or her personal identification number from the touch panel display 11. The user enters his or her personal identification number (S110). The entered personal identification number is transmitted to the financial institution host system 70 through the communication controller 43 of the terminal operations center 40 (S111). Consequently, the financial institution server 71 transfers the certificate issuance fee from the user's account into the designated self-governing community's account. It should be noted that the relevant data in the account management database 72 is updated by this processing.

If the fee has been paid correctly (S113), the financial institution server 71 transmits a notice of payment to the acceptance terminal 10 through the terminal operations center 40. When the notice of payment is received at the acceptance terminal 10, a receipt printed with the receipt number is output from the receipt output section 13 (S113). Finally, the cash card is ejected from the card read section 12, and thus the application processing is terminated (S114).

If the registration has not been made correctly at S107, or if the fee has not been paid correctly at S112, the acceptance terminal 10 communicates with the terminal operations center 40 to cancel the accepted application at that time (S115), and ejects the card or the like inserted in the card read section 12 (S116).

It should be noted that the time for payment of the fee is not necessarily limited to the time at which application is made. The system may be arranged such that the user can pay the fee when receiving the desired certificate. There is no particular restriction on the payment of the fee.

Upon completion of the application, the certificate can be issued at any time from a certificate issuing machine 20 provided for each self-governing community.

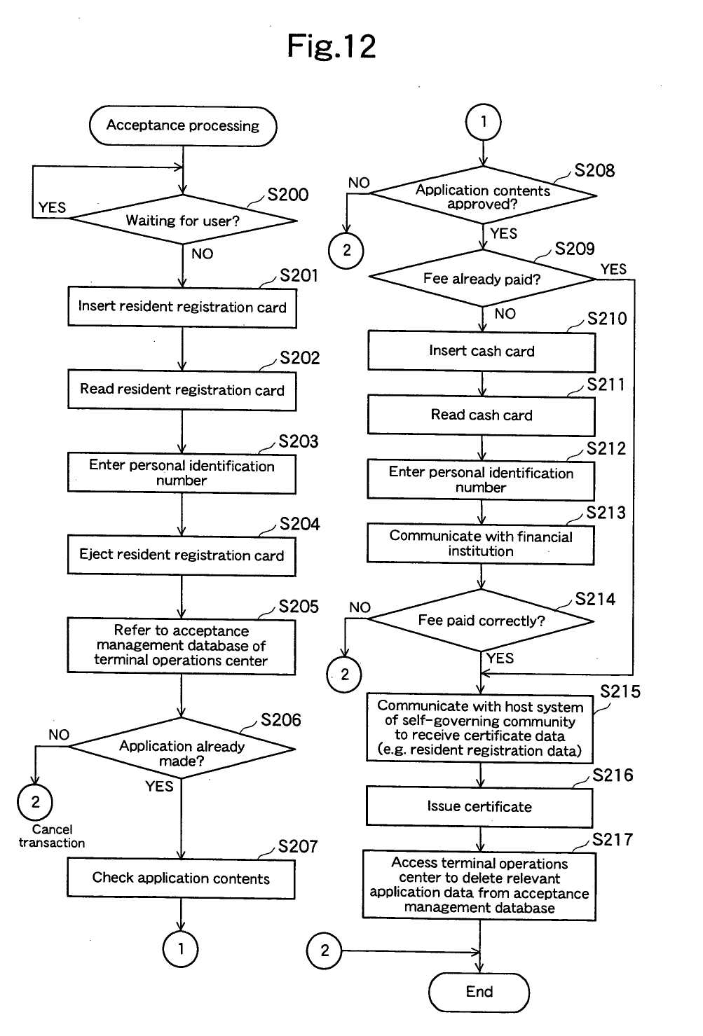

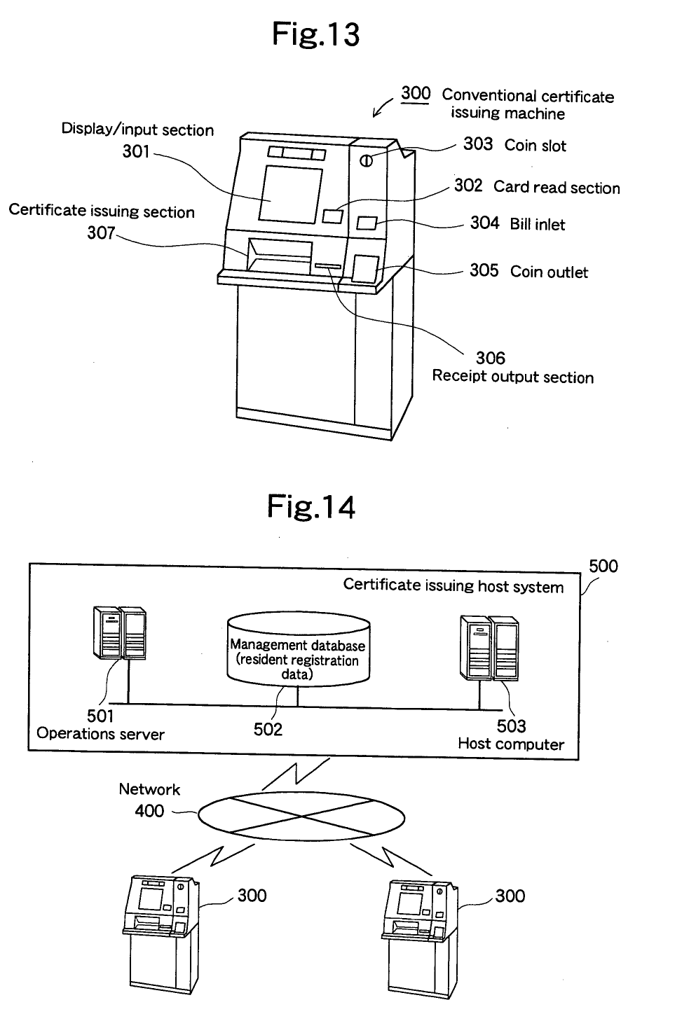

Next, certificate issuing processing will be described. FIG. 12 is a flowchart showing certificate issuing processing carried out by the certificate issuing machine 20. It should be noted that the following is a description of issuing processing with a system arranged such that the time for payment of the fee is not limited to the time at which application is made, but the user can pay the certificate issuance fee when receiving the desired certificate. The certificate to be issued is assumed to be a certificate of residence.

When it is in a standby state, the certificate issuing machine 20 continues to display input operation guidance (not shown) on the touch panel display 21 (S200).

Following the input operation guidance, the user inserts his or her resident registration card into the card read section 22 (S201). The card read section 22 reads information (ID) recorded on the resident registration card (S202). At this time, the user enters his or her personal identification number registered when the resident registration card was prepared at the self-governing community office in order to confirm even more surely that the person using the resident registration card is the real owner of the card (S203). Consequently, the main control section 26 of the certificate issuing machine 20 makes a reference to the system of the relevant self-governing community to execute processing for confirming that the user is the real owner of the resident registration card. After the confirmation has been made, the resident registration card is ejected from the card read section 22 (S204). Further, the user enters the receipt number assigned at the time of making application from the touch panel display 21.

Subsequently, the main control section 26 transmits the read information and the entered receipt number to the terminal operations center 40 through the communication control section 25. The transmitted information is referenced against the acceptance management database 416 by the application registration confirming section 415 of the terminal operations center 40 to check whether or not the application has already been made (S205).

If the application has not yet been made (if NO at S206), the issuing processing is canceled and terminated. If the application has already been made (if YES at S206), the application registration confirming section 415 checks the application contents in the acceptance management database 416 (S207). If the application contents are not approved (if NO at S208), the issuing processing is canceled and terminated. If the application registration confirming section 415 approves the application contents (if YES at S208), it is checked by referencing the acceptance management database 416 whether or not the certificate issuance fee has already been paid (S209). If the fee has not yet been paid (if NO at S209), fee payment processing is carried out. The fee payment processing (S210 to S214) is similar to the processing carried out at S108 to S112 in FIG. 7. Therefore, a description thereof is omitted.

Subsequently, the certificate transmitting and receiving section 417 of the acceptance terminal operations server 41 receives a notice of confirmation from the application registration confirming section 415 and consequently connects to the certificate issuing host system of the relevant self-governing community to receive certificate data (S215). For example, when a residence certificate in City A is to be issued, the ID of the resident registration card and the application contents are transmitted from the acceptance terminal operations server 41 to the certificate issuing host system 50 of City A. The residence certificate issuing machine operations server 51 checks the host computer 53 for the application registration. After confirming that the application registration has been made, the residence certificate issuing machine operations server 51 acquires data necessary for residence certificate preparation from the management database 52 on the basis of the ID of the resident registration card and the application contents received from the acceptance terminal operations server 41. The residence certificate issuing machine operations server 51 prepares a residence certificate by using the acquired data and transmits it to the terminal operations center 40.

Upon receiving residence certificate data, the certificate transmitting and receiving section 417 of the acceptance terminal operations server 41 transmits the residence certificate data to the certificate issuing machine 20 from which the issuance instruction has been given. The transmitted residence certificate data is printed out onto a predetermined sheet from the certificate issuing section 24 through the communication control section 25 of the certificate issuing machine 20 (S216). After the residence certificate has been issued, the application registration confirming section 415 of the acceptance terminal operations server 41 deletes the relevant application data from the acceptance management database 416 (S217).

With the above-described processing, certificate issuance is performed reliably and speedily.

In the foregoing embodiment, the issuance of a certificate is carried out through a terminal (certificate issuing machine 20) different from the acceptance terminal 10 after the application has been made. It should be noted, however, that the acceptance terminal 10 and the certificate issuing machine 20 may be integrated into a single terminal having the functions of both of them to allow certificate issuance application and certificate issuance to be carried out simultaneously.

Further, although in the foregoing embodiment the issuance of a certificate is carried out through the certificate issuing machine 20, the system may be arranged to allow the user to specify a manner of issuance at the time of making application at the acceptance terminal 10. For example, the system may be arranged to allow the user to select any of the following manners of issuance: issuance from the certificate issuing machine 20; direct issuance at a municipal office or the like; and issuance by main. With this arrangement, the system can cope appropriately with the user's circumstances. Thus, convenience further improves.

Although various embodiments of the present invention have been described above, the present invention is not necessarily limited to the foregoing embodiments but can be applied in a variety of ways without departing from the gist of the present invention.

Industrial Applicability:

As has been stated above, according to the present invention, simple application acceptance terminals for certificate issuance that are mutually usable between a plurality of self-governing communities, e.g. municipal offices, are installed at various places in the streets, thereby eliminating the need to install application acceptance terminals for each self-governing community. In other words, it is possible to access a plurality of self-governing communities by using a single application acceptance terminal. Therefore, convenience in making an application improves. Further, an application form is prepared on the basis of format information acquired for each specified self-governing community. Therefore, even if the formats of various application forms differ for each self-governing community, an application form can be prepared easily. Further, because an application form is automatically prepared once necessary items are entered, the manner of handling at the time of data entry can be made common to self-governing communities. Accordingly, the terminal operating method will not become complicated. Thus, it is possible to provide a system that is easy for users to use. In addition, because neither the application acceptance terminal nor the certificate issuing machine handles cash, it is unnecessary to carry out security management that would otherwise be required in connection with cash collection and cash storage. Hence, it becomes possible to reduce the system running costs.

1. A certificate issuance application system comprising:
a first input section through which an applicant selects and enters a desired self-governing community;
a second input section through which the applicant enters predetermined information necessary for certificate issuance application;
a format acquiring section that acquires from a predetermined storage section format information concerning an application form for certificate issuance that is used in the self-governing community selected and entered through said first input section; and
an application form preparing section that prepares an application form for certificate issuance that is used in the self-governing community selected and entered through said first input section by using the predetermined information entered through said second input section on a basis of the format information acquired by said format acquiring section.

2. A certificate issuance application system according to claim 1, further comprising:
a third input section through which the applicant enters a type of certificate desired to be issued;
wherein said format acquiring section acquires from said predetermined storage section format information concerning an issuance application form used in the self-governing community selected and entered through said first input section on a basis of the type of certificate entered through said third input section.

3. A certificate issuance application system according to claim 1, wherein selective entry processing performed through said first input section is carried out by using a predetermined storage medium storing at least information for identifying a self-governing community to which the applicant belongs.

4. A certificate issuance application system according to claim 1, wherein the format information acquired by said format acquiring section includes at least one of information concerning items written on an application form, a number of digits of each item, and a position of each item on an application form sheet.

5. A certificate issuance application system according to claim 1, further comprising:
a fourth input section through which the applicant enters information concerning his or her account at a financial institution;
a connecting section that is capable of connecting to a deposit management system of the financial institution; and
a fee transfer section that transfers through said connecting section a certificate issuance fee from the user's account at the financial institution into an account of the self-governing community entered through said first input section on a basis of the information entered through said fourth input section.

6. A certificate issuance application system according to claim 1, further comprising:
an application form transmitting section that transmits the application form prepared by said application form preparing section to the self-governing community entered through said first input section.

7. A certificate issuance application system according to claim 1, wherein said first input section and said second input section are installed at a plurality of places as application acceptance terminal apparatus,
wherein said application acceptance terminal apparatus is connected to a host computer having said format acquiring section and said application form preparing section through a telecommunication circuit.

8. An application acceptance terminal apparatus comprising:
a first input section through which an applicant selects and enters a desired self-governing community;
a second input section through which the applicant enters predetermined information necessary for certificate issuance application; and
a communication section that connects through a telecommunication circuit to a host computer having a format acquiring section that acquires from a predetermined storage section format information concerning an application form for certificate issuance that is used in the self-governing community selected and entered through said first input section, said host computer further having an application form preparing section that prepares an application form for certificate issuance that is used in the self-governing community selected and entered through said first input section by using the predetermined information entered through said second input section on a basis of the format information acquired by said format acquiring section.

9. A host computer comprising:
a communication section that connects through a telecommunication circuit to an application acceptance terminal apparatus having a first input section through which an applicant selects and enters a desired self-governing community, said application acceptance terminal apparatus further having a second input section through which the applicant enters predetermined information necessary for certificate issuance application, said communication section being capable of receiving data entered at said application acceptance terminal apparatus;
a format acquiring section that acquires from a predetermined storage section format information concerning an application form for certificate issuance that is used in the self-governing community selected and entered through said first input section; and
an application form preparing section that prepares an application form for certificate issuance that is used in the self-governing community selected and entered through said first input section by using the predetermined information entered through said second input section on a basis of the format information acquired by said format acquiring section.

10. A certificate issuance application method comprising:
a first input step at which an applicant selects and enters a desired self-governing community;
a second input step at which the applicant enters predetermined information necessary for certificate issuance application;
a format acquiring step at which format information concerning an application form for certificate issuance that is used in the self-governing community selected and entered at said first input step is acquired from a predetermined storage section; and
an application form preparing step at which an application form for certificate issuance that is used in the self-governing community selected and entered at said first input step is prepared by using the predetermined information entered at said second input step on a basis of the format information acquired at said format acquiring step.

11. A certificate issuance application method according to claim 10, further comprising:
an application form transmitting step at which the application form prepared at said application form preparing step is transmitted to the self-governing community entered at said first input step.

12. A certificate issuance application program stored in a computer-readable storage medium to instruct a computer to execute certificate issuance application processing, said program instructing the computer to execute:
a first input step at which an applicant selects and enters a desired self-governing community;
a second input step at which the applicant enters predetermined information necessary for certificate issuance application;
a format acquiring step at which format information concerning an application form for certificate issuance that is used in the self-governing community selected and entered at said first input step is acquired from a predetermined storage section; and
an application form preparing step at which an application form for certificate issuance that is used in the self-governing community selected and entered at said first input step is prepared by using the predetermined information entered at said second input step on a basis of the format information acquired at said format acquiring step.

13. A certificate issuance application program according to claim 10, which further instructs the computer to execute an application form transmitting step at which the application form prepared at said application form preparing step is transmitted to the self-governing community entered at said first input step.

14. A certificate issuing system comprising:
a first input section through which an applicant selects and enters a desired self-governing community;
a second input section through which the applicant enters predetermined information necessary for certificate issuance application;
a format acquiring section that acquires from a predetermined storage section format information concerning an application form for certificate issuance that is used in the self-governing community selected and entered through said first input section;
an application form preparing section that prepares an application form for certificate issuance that is used in the self-governing community selected and entered through said first input section by using the predetermined information entered through said second input section on a basis of the format information acquired by said format acquiring section;
an application form transmitting section that transmits the application form prepared by said application form preparing section to the self-governing community entered through said first input section;
a certificate preparing section that prepares a certificate based on the application form transmitted by said application form transmitting section; and
a certificate issuing section that issues the certificate prepared by said certificate preparing section.

15. A certificate issuing method comprising:
a first input step at which an applicant selects and enters a desired self-governing community;
a second input step at which the applicant enters predetermined information necessary for certificate issuance application;
a format acquiring step at which format information concerning an application form for certificate issuance that is used in the self-governing community selected and entered at said first input step is acquired from a predetermined storage section;
an application form preparing step at which an application form for certificate issuance that is used in the self-governing community selected and entered at said first input step is prepared by using the predetermined information entered at said second input step on a basis of the format information acquired at said format acquiring step;
an application form transmitting step at which the application form prepared at. said application form preparing step is transmitted to the self-governing community entered at said first input step;
a certificate preparing step at which a certificate is prepared based on the application form transmitted at said application form transmitting step; and
a certificate issuing step at which the certificate prepared at said certificate preparing step is issued.

16. A certificate issuing program stored in a computer-readable storage medium to instruct a computer to execute certificate issuing processing, said program instructing the computer to execute:
a first input step at which an applicant selects and enters a desired self-governing community;
a second input step at which the applicant enters predetermined information necessary for certificate issuance application;
a format acquiring step at which format information concerning an application form for certificate issuance that is used in the self-governing community selected and entered at said first input step is acquired from a predetermined storage section;
an application form preparing step at which an application form for certificate issuance that is used in the self-governing community selected and entered at said first input step is prepared by using the predetermined information entered at said second input step on a basis of the format information acquired at said format acquiring step;
an application form transmitting step at which the application form prepared at said application form preparing step is transmitted to the self-governing community entered at said first input step;
a certificate preparing step at which a certificate is prepared based on the application form transmitted at said application form transmitting step; and
a certificate issuing step at which the certificate prepared at said certificate preparing step is issued.
